(19) United States
(12) Patent Application Publication
(10) Pub. No.: US 2014/0208102 A1
(43) Pub. Date: Jul. 24, 2014

(54) METHOD OF PROTECTING DIGITAL INFORMATION

(71) Applicants: Evgeniy Ivanovich Pryakhin, St. Petersburg (RU); Ekaterina Vladimirovna Larionova, St. Petersburg (RU); Viktor Jurevich Piraynen, St. Petersburg (RU); Aleksandr Jurevich Garkushev, St. Petersburg (RU)

(72) Inventors: Evgeniy Ivanovich Pryakhin, St. Petersburg (RU); Ekaterina Vladimirovna Larionova, St. Petersburg (RU); Viktor Jurevich Piraynen, St. Petersburg (RU); Aleksandr Jurevich Garkushev, St. Petersburg (RU)

(21) Appl. No.: 13/807,602

(22) PCT Filed: Apr. 27, 2012
(86) PCT No.: PCT/RU12/00335

§ 371 Date: Dec. 28, 2012

(51) Int. Cl. G06F 21/62

(52) U.S. Cl. CPC G06F 21/62
USPC 713/165

(57) ABSTRACT

The method provides encoding digital information by assigning encoding values from a plurality of collectives of encoding values to the message symbols. The collectives are unbound from each other, are selected randomly, and setting a correspondence between the symbols and encoding values of the selected collectives is random. Elements of the encoded message can be further assigned encoding values of further selected collectives. The method can be implemented both in virtual form using Cloud Computing technology and in a physical form, where encryption and decryption blocks are implemented in one environment physically protected against unauthorized access, writing and copying. Performing encoding and decoding in a user-inaccessible environment and providing the user only with the results of encoding and decoding processes prevents unauthorized access thereto from occurring.

The technical result is widening the field of use, improved reliability and security of the digital and analog information.

### CROSS-REFERENCE TO RELATED APPLICATIONS

This application is a continuation-in-part U.S. National phase application of the International application PCT/RU2012/000335, filed Apr. 27, 2012, the entire contents of this application being hereby incorporated into the present application by reference in full.

### BACKGROUND OF THE INVENTION

1. Field of the Invention

The invention generally relates to the information protection means against unauthorized survey, content modification, information content integrity manipulation during the information storage and transfer and it can be implemented in software, hardware and hard/software means of multilevel, including cryptographic, information protection against survey and means of information control and information integrity recovery. The proposed method is designed to protect digital information of various type, namely—text, graphics, video, audio, executable files etc., as well as to protect analog information that was converted into digital form by technical means.

2. Description of the Related Art

Modern technologies provide an opportunity to transmit and store large amount of information. This has a backside as well. Information becomes more and more vulnerable for different reasons:
the amount of data to store and transfer rises;
the user community having access to computer resources, software and data widens;
computer system exploitation modes become more complicated.

Thus the information protection against unauthorized access while storing and transmitting comes into growing importance. The essence of this problem is the everlasting fight between computer information protection specialists and their “opponents”.

Different systems and devices for information protection and transfer are known. For example, the Russian Patent No. 2370898 describes a method of information protection against unauthorized access in telecommunication systems. The technical result is the preventing of key information from intercepting near a receiving antenna. The concept of invention is that an array of random numbers providing a basis of generating symmetric encryption keys is created in both transmitting and receiving points of telecommunication by measuring both ways the random time necessary for probing radio signals to come from a transmitter to a receiver. The keys are generated by means of irreversible transformations of large plurality of measurements of time necessary for probing radio signals to come from the transmitter to the receiver, which has been collected within a predetermined information protection technical means working time interval, the collected plurality of measurements being constantly appended with subsequent measurement results.

This method has the following disadvantages: it misses protection against interferences, both natural and intentional, as well as against distortions in telecommunication channels, it lacks the precise estimate of the probability of imposing false information, thus providing no guarantee that the decryption key is acquired correctly.

The Russian Patent No. 2423800 describes the information protection method based upon bidirectional transmission and subsequent detection of probing radio signals carrying their generation time stamps bounded to pre-reduced time scales, and coming from telecommunication devices located at both ends of the radio channel, irreversible mathematical transformation of numerical sequences, message encryption and decryption with a key, characterized by the steps of carrying out a mutual recognition procedure for information exchange participants, synchronizing time scales for communication devices of every participant, defining a time interval of the work of information protection means, accumulating at the both ends of the radio channel during this interval two coinciding arrays of binary equivalents of digitized results of measuring a random natural process of the phase change of received probing signals which are a superposition of component beams with unpredictable phase progression propagating in a multipath environment, subjecting the accumulated arrays of binary equivalents to irreversible mathematical transformations coinciding at the both ends of the radio channel, forming two identical copies of a key of symmetric encryption at the transmitting and receiving ends, and augmenting the accumulated binary equivalent arrays with binary equivalents of digitized results of subsequent measurements of the probing signal phase, reciprocity of radio wave multipath propagation being used as a mechanism of symmetric encryption key distribution.

The prior art offers protection against interference at telecommunication lines by synchronizing the operation of mutual recognition information exchange participants by special time scales, because mathematical operations are carried out synchronized at the accumulation of binary analogs of measurements, thus they are carried out by certain algorithm that can be mathematically discovered and decrypted. Besides, users must have complicated supersensitive equipment that, if failed, may make it impossible to protect and transmit.

The invention according to Russian Patent Application No. 2001117145 discloses a protection method based upon generating a key to be stored in a memory of an external device adapted to be connected to a computer, decrypting information with the use of the key, characterized by that the key is generated immediately in the external device, the encryption of the information being performed in the same device with the use of the key.

The key generation in this case is carried out with the use of pseudorandom sequence signals and signals of external random influence with the subsequent automatic verification of the key for the absence of coinciding with the keys stored in the external device memory.

The generation of the key during the information exchange between end users is carried out by the external device of one of users, encrypting the encryption thereof is performed with a system key that was earlier recorded into the system key memory of all the devices of the end users of the same series, and then the encrypted key is transmitted to the other user and is decrypted at the other user's device, the encrypting of the information being conducted with the use of the key in the external devices of each of the users.

It is proposed that the apparatus be implemented in a single environment protected from unauthorized access, for example, in a one-chip microcontroller.

The disadvantage of this method id that it cannot be used in case of a force-majeure situation such as end user equipment failure or the same of some segments of the equipment. Besides, this method implements the controlling sequence (key) that is either shorter than or matches the length of the message, and the precise evaluation of the probability of imposing false information is missing, thus raising the chance of break-in or calculating a bypass way to decrypt the protected information.

The Russian Patent No. 2254685 describes a method of information encrypting conversion. According to this method, prior to starting the encryption, all possible non-recurrent alphabet combination values uᵢ are randomly written with the use of a random number generator (RNG) into a code table with N lines. Written into every line u, of an address table Tₐ is a number of line i of a code table Tₖ which an alphabet combination value uᵢ is written in, where N is the size of the alphabet coinciding with the number of lines in the code and address tables Tₖ and Tₐ, while uᵢ is the initial combination to be encrypted. In doing so and to fill yet another i^{th} line in the code table Tₖ, where i is the value from 1 to N, yet another alphabet combination value acquired from the RNG is compared with each of i−1 values of alphabet combinations written into the code table Tₖ, and, in case no coincidence with any written earlier alphabet combinations is found, the yet another alphabet combination uᵢ is being written into the i^{th} line of the code table Tₖ. When encrypting, an address A(uᵢ) of the initial combination uᵢ in the code table Tₖ is read out from, the value of the encrypted combination vᵢ of the initial alphabet combination uᵢ with conversion parameter value ξᵢ being equal to the alphabet combination value stored in line A(vᵢ) of the code table Tₖ, the address of which is defined as A(vᵢ)=A(uᵢ)+ξᵢ, by modulus of the number N, the encrypted combination value vᵢ is read out from the code table Tₖ line with address A(vᵢ). Upon decrypting the encrypted combination v, with conversion parameter value ξ₁, determined are the value of the combination stored in the line with address A(uᵢ) in the code table Tₖ, and the address A(uᵢ)=A(vᵢ)−ξᵢ by modulus of the number N, and the value of the combination uᵢ is read out from the line of the code table Tₖ with the address A(uᵢ).

Likewise, the abovementioned method cannot be implemented in case of force-majeure situation such as an end user equipment failure or the failure of equipment segments; as well as where a controlling sequence (key) is either shorter than or matches the message length. Besides, this method may need significant equipment capabilities, including the same of computer, still keeping the process complicated and slow thus making it impractical.

The closest to the proposed invention by the combination of essential features is a method of item marking for the purpose of identification as described by Russian Patent Application No. 2011111052, taken by the authors as a prototype. One of the aspects of this prior art is a method of forming a code message and encrypting the same. The prototype is based upon the principle of the encoding system formation on a binary basis with 0 and 1, and it is accepted that “1” means the presence, while “0” means the absence, of laser influence imprinting. Any bit information can be encoded, including Latin letters, digits, punctuation symbols, national fonts, pseudo graphical symbols, etc., representing in general an array of symbols. Any symbol of this array can be represented as a multidigit combination of 0 and 1. For example, eight-digit symbol code system can be used, and then it looks like 00000000, 00000001, 00000010, etc.

The area occupied by placing a single symbol with a local spot heat source is 50×8=400 mkm width and 50 mkm height, with the imprint diameter of 50 mkm. A text page with 30 lines, 80 symbols each, occupies the area of 32×1.5 mm.

Any type of a file can be represented in a symbol format, be it textual, graphical, acoustic, or other.

The essence of the prior art technical solution lies in encrypting the information written as an encoded message on the surface of an item by forming particular code arrays out of the general array of symbols, a particular code array being the initial general code array whose components are randomly mixed.

The known method discloses only one method of encoding based upon custom individual code systems, created by user, and it is for marking metal items, and it does not suggest protection of digital information represented in different ways. The prior art method does not provide embedding coding systems and/or adding thereof.

It is known that cryptographic protection methods use various ways to generate pseudorandom sequences that are formed both in encryption and decryption points controlled by some secret key, processing time rising significantly with the rise of encryption depth determined by the ratio between the volume of the encrypting sequence (key) and the volume of the information transmitted. The information being transmitted is known to be vulnerable for interception, and the information protection is provided by deep encryption based on the use of encryption keys (private and/or public) that are known to parties.

### SUMMARY OF THE INVENTION

The object of the present invention is to provide such a method of protecting digital information represented in various forms thereof, which, preserving all the advantages of symmetric encryption, would at the same time allow controlling information integrity (preventing imposing false information from occurring), thwarting reading confidential information from the system; providing for a steady and fast implementation of the information protection method while keeping the multilevel deep encryption uncompromised.

The claimed method belongs to means aimed at providing for encoding, protecting, and decoding of information of various kinds with the use of unique multilevel encoding methods, including those of both symmetric and asymmetric encryption. The technical result of the proposed invention is to widen field of use, to enhance reliability and security of the digital information protection method.

To implement the digital information protection method according to the present invention, a program controlled system is used, a user only having access to an interface of the system that is protected against copying, modifying or transmitting fragments thereof or in its entirety.

When implementing the claimed method in a virtual form, cloud computing technologies are used allowing user access to coding options and protecting against intentional destructive influence on information and an encoding system.

When implementing the claimed method in a physical form, encoding and decoding units are implemented in a single environment physically protected against unauthorized access, writing and copying.

For encoding, cryptographic methods of symmetric encryption are used with the following distinctive features. A user converts information of any available kind into a digital form. The bit information needing protection (i.e. digital information or analog one converted into the digital form) is encoded with the use of the collective of particular encrypting values obtained by the random mixing of the general collective of values, the general collective being formed out of mutually unbounded initial arrays of values. For encoding, any collectives of values of the correspondence of codes and symbols can be used, including both known (UNICODE) and user-made ones based on binary, decimal, hexadecimal, and other systems. In this case, each symbol being encoded can correspond to different values from one or several collectives, in view of these collectives being mutually unbounded. That means that no value of one collective can be obtained out of one or several values of another collective by any mathematical, logical or other methods. In so doing, encoding collectives can be enclosed, i.e. the encoded information can be further encoded n times in the collective of encoding values or the addition thereof, i.e. code in code. Adding coding collectives lies in the correspondence of several values from the collectives, one from each collective, the values being assigned randomly, thus excluding unauthorized decryption by a brute force attack for both most and less frequently occurring symbols.

Encoding can be performed for any digital information. The information encoded or encrypted mathematically is known to be as a rule computable and, thus, decryptable, fully or in parts. The exclusion of mathematical methods for selecting a controlling sequence (key) in the present invention results from the use of random values and randomization in forming a particular collective, thus significantly enhancing reliability of the system. In adding the collectives of encoding values, a plurality of unbounded random values from those collectives correspond to each symbol of the information being encoded, the length of words and the number of bits used being varied. The amount of enclosures and additions is not limited and can be combined in a pre-assigned order or randomly. Thus, the symmetric encoding system implements asymmetric encryption principle.

### BRIEF DESCRIPTION OF THE DRAWINGS

The only drawing sketches out main operations of the method according to the present invention.

### DETAILED DESCRIPTION OF THE INVENTION

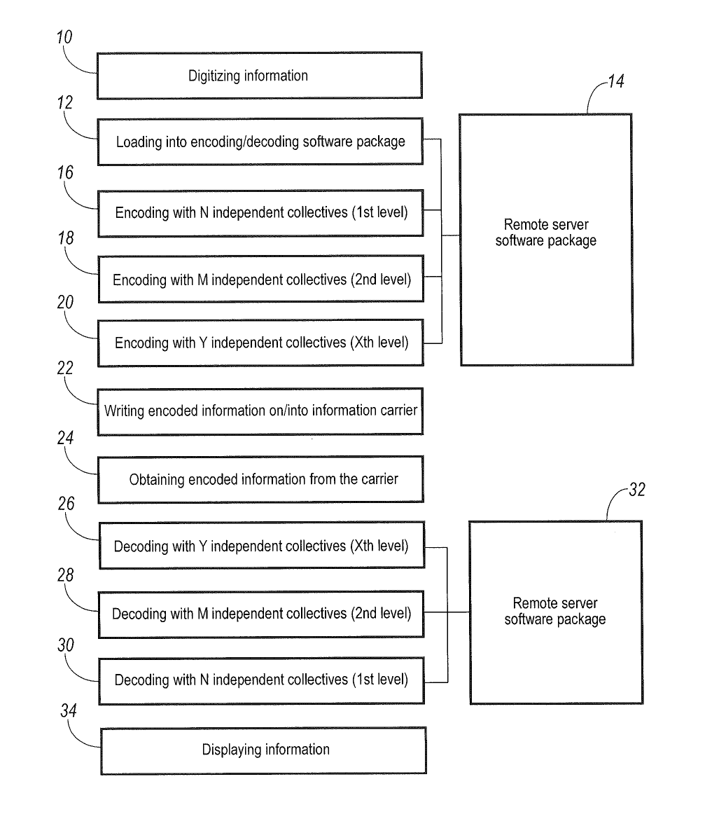

The method according to the present invention is realized is as follows. Coding conditions are defined by a user in a computer controlled system (in a software package at a remote server), implementing principles of the present method. Then, the information that needs to be encrypted is loaded in a digital format, or converted into one in advance (steps 10, 12 and 14 in FIG. 1). After that, an encryption is performed and written in a bit form. Depending on the selection of the encoding parameters, the process of encryption is preferably conducted several times so that already encrypted information (step 16) can be subjected to further encoding (steps 18, 20). In other words, the software package encodes at levels (1 . . . X) using Q collectives of values, N, M, and Y being particular cases. After the information has been encoded, it is written on/into an information carrier (step 22). The method according to the present invention can be used, for example, in the course of applying encrypted information to the information carriers, i.e. any material item containing or carrying information and capable for a long time of keeping within its structure the information written into/on it, i.e. various items (materials, parts, pieces, items, documents) and devices and carriers of digital information, as, for example, it is disclosed in copending application “Method of marking an object to identify same”, Ser. No. 13/513,230 filed Jun. 1, 2012, the entire contents of this application being hereby incorporated into the present application by reference in full. To visualize the information, it is first read out from the carrier (step 24) and then is subjected to decoding in a reverse order (steps 26, 28, 30) with the use of the remote server software package (step 32) and then is displayed (step 34). The decoded information can be put onto conventional carriers (CD disks, flash carriers, etc.) using standard digital formats (tex-txt., video-avi., musical-mp3, etc.). As a result, accessible to the user is the interface only, rather than the software package itself. That means that the user only has information to be protected, and, after loading and processing same, the user has an encrypted bit message. The software package is protected against copying, modification, or transmitting in parts or entirely. Thus neither user nor potential intruder has any opportunity to uncover either an encryption algorithm or a controlling sequence (the key). The controlling sequence can be either of equal length to the information to be encrypted or be longer, thus assuring the message authentication and information integrity monitoring (preventing from imposing false information). As a result, the system is risk-free against break-in, decryption, imposing false information, and its degree of protection is the highest possible.

According to the present invention, the information protection is realized as follows:

There exists a message consisting of n symbols (a₁, b₁, z₁) that has m repetitions of any one or several symbols (e.g. a₁, a₂, . . . , aₘ). There exists Q collectives Aᵢ, where i belongs to the multitude (1, . . . , Q), used for a random assignment of encoding values, to the message symbols (a₁, b₁, . . . , z₁). Setting the correspondence between the symbols and encoding values in the collectives (A₁, . . . , A_{Q}) occurs randomly. The first symbol aᵢ is randomly assigned a value from the collective Aᵢ. The symbol aₘ can be assigned a value from a collective Aⱼ, selecting the collective within the range (A₁, . . . , A_{Q}) being made randomly either. Likewise, other symbols (b₁, c₁, . . . , z₁) gain their values. At the same time, the same symbol aₙ repeating itself in different parts of the message can be β times assigned an encoding value from the collective Aᵢ, assigning encoding values from the first collective occurring β₁, times, assigning encoding values from the second collective occurring β₂ times, etc., if there are less collectives than the number of repetitions of the symbol in the message, the amount β of assigning encoding values from various collectives to the same symbol being a random value.

Table 1 represents examples of particular encoding collective variants within the range from Q₁ to Q₃ for the message having the message symbols.

TABLE 1

| | Collective | | Collective | | Collective | |
|---|---|---|---|---|---|---|
| Message | | Binary | | Binary | | Binary |
| symbol | A₁ | representation | A₂ | representation | A₃ | representation |
| a | 51 | 00110011 | 79 | 01001111 | 188 | 01010110 |
| [symbol] | 67 | 00101000 | 136 | 10001000 | 40 | 01000011 |
| B | 54 | 00110110 | 6 | 00000110 | 245 | 11110101 |
| Γ | 234 | 11101011 | 210 | 11010010 | 79 | 01001111 |
| [symbol] | 26 | 00011010 | 199 | 11000111 | 228 | 11100100 |
| e | 230 | 11100110 | 43 | 00101011 | 161 | 10100001 |
| [symbol] | 231 | 11100111 | 176 | 10110000 | 8 | 00001000 |
| 3 | 728 | 11011111 | 157 | 10011101 | 220 | 11011100 |
| [symbol] | 103 | 01100111 | 399 | 11000111 | 276 | 10110000 |
| [symbol] | 259 | 11111010 | 87 | 01010111 | 149 | 10010101 |
| [symbol] | 187 | 10111011 | 91 | 01011011 | 233 | 11101001 |
| [symbol] | 122 | 01111010 | 8 | 00001000 | 160 | 10100000 |
| M | 22 | 00010110 | 169 | 10101001 | 152 | 10011000 |
| H | 239 | 11101111 | 219 | 11011011 | 183 | 10110111 |
| o | 250 | 11111010 | 28 | 00011011 | 86 | 01010110 |
| π | 38 | 00100110 | 186 | 10111010 | 173 | 10101101 |
| p | 218 | 11011010 | 65 | 01000001 | 71 | 01000111 |
| c | 251 | 11111011 | 130 | 10000010 | 203 | 11001011 |
| T | 138 | 10001010 | 71 | 01000111 | 42 | 00101010 |
| y | 150 | 10001100 | 140 | 10010110 | 223 | 11011111 |
| φ | 184 | 10111000 | 51 | 00110011 | 189 | 10111101 |
| x | 84 | 1010100 | 72 | 01001000 | 226 | 11100010 |
| [symbol] | 235 | 11101011 | 107 | 01101011 | 67 | 01000011 |
| [symbol] | 21 | 00010101 | 202 | 11001010 | 146 | 10010010 |
| [symbol] | 273 | 11011111 | 125 | 01111100 | 98 | 01100010 |
| [symbol] | 241 | 11110001 | 102 | 11001010 | 476 | 10110000 |
| [symbol] | 94 | 01011110 | 242 | 11110010 | 134 | 10000110 |
| [symbol] | 156 | 10011100 | 253 | 11111101 | 249 | 11111001 |
| [symbol] | 254 | 11111111 | 27 | 00011011 | 54 | 00110110 |
| [symbol] | 226 | 11100010 | 195 | 11000011 | 36 | 00100100 |
| [symbol] | 154 | 10011010 | 159 | 10011111 | 212 | 11010100 |
| [symbol] | 162 | 10011100 | 124 | 01111100 | 72 | 01001000 |

It can be noticed, for example, for the symbol “a”, that in a collective Aᵢ a digital value, different from that in any other collective Aᵢ₋₁ can correspond thereto. For example, the collective A₁ assigns value 51 to the symbol “a”, while the collective A₂ assigns the value 79 to the symbol “a”, etc. Doing so makes it possible to rule out using a statistical method of decrypting based on a certain pattern in repeating symbols such as letters in a text. Thus, according to the present invention, encoding resulting in a random sequence of encrypting values from the collectives, which is independent of particular sign/symbol statistics in the initial information, is provided.

In the foregoing example, the area of value assignment is limited by natural numbers (particular case). The present invention does not have limitations of this kind: the information user may set variants of assigning various values to symbols, where the values may belong to the multitudes of natural, integer numbers, real numbers, and other multitudes, as well as letters, national fonts, pseudo graphics, etc.

Encrypted below as an example, with all kinds of fonts, symbol modifications, punctuation, reserved symbols, spaces, and word wraps kept intact, is the following information. For convenience, the beginning and the end of the message are designated as //Message begins and //Message ends, respectively:

//Message begins

1. Encryption—is a conversion of data into unreadable form using encryption-decryption keys.
2. Cryptography—is the science about methods of information conversion (encryption) aimed to protect it against unauthorized users (encryption development, cipher design).
3. Cryptanalysis—is the science (and common practice) about methods and ways of cracking ciphers (attacks against encryption).
//Message ends

To generate a general collective of the first level (by adding particular collectives), a combination of controlling values was randomly built for each of the symbols being encrypted. With regard to their length, the collectives are by no means correlated with the encoded message. For example, one of the particular collectives represents, prior to conversion, the Russian Alphabet by user's selection, including uppercase and lowercase letters. The message contains 47 symbols while the alphabet has 64 symbols. Table 2 represents a fragment of such a collective, the column ‘Initial message symbols’ showing Russian letters as in the original.

TABLE 2

| Initial | | | | |
|---|---|---|---|---|
| message | Individual | Individual | Individual | Individual |
| symbols | plurality A₁ | plurality A₂ | plurality A₃ | plurality A₄ |
| 1 | 86 | [symbol] | e | ″ |
| . | 190 | [symbol] | [symbol] | & |
| [symbol] | 179 | \| | [symbol] | < |
| [symbol] | 9 | [symbol] | [symbol] | > |
| Φ | 32 | [symbol] | [symbol] | . . . |
| P | 114 | [symbol] | [symbol] | → |
| O | 92 | [symbol] | π | ← |
| B | 41 | [symbol] | a | ↑ |
| A | 75 | [symbol] | Γ | ↓ |
| H | 35 | ∥ | e | † |
| E | 184 | [symbol] | Φ | ‡ |
| - | 234 | [symbol] | X | \hat{ } |
| [symbol] | 125 | [symbol] | [symbol] | [symbol] |
| T | 167 | [symbol] | [symbol] | ‘ |
| Π | 81 | [symbol] | [symbol] | ’ |
| [symbol] | 237 | [symbol] | [symbol] | “ |
| [symbol] | 89 | ⊥ | [symbol] | ” |
| [symbol] | 228 | [symbol] | o | · |
| [symbol] | 12 | [symbol] | y | - |
| X | 86 | — | [symbol] | — |
| [symbol] | 190 | [symbol] | [symbol] | ~ |
| [symbol] | 179 | [symbol] | [symbol] | ™ |
| [symbol] | 9 | [symbol] | A | |
| [symbol] | 32 | [symbol] | [symbol] | [symbol] |
| [symbol] | 114 | [symbol] | [symbol] | ¢ |
| M | 92 | [symbol] | [symbol] | £ |
| C | 75 | [symbol] | [symbol] | [symbol] |
| [symbol] | 35 | = | p | |
| κ | 184 | [symbol] | c | ? |
| ‘ | 234 | [symbol] | [symbol] | ¦ |
| 2 | 125 | [symbol] | [symbol] | § |
| κ | 167 | [symbol] | [symbol] | \ddot{ } |
| Γ | 81 | [symbol] | e | © |
| - | 237 | [symbol] | M | a |
| [symbol] | 89 | [symbol] | [symbol] | [symbol] |
| [symbol] | 228 | [symbol] | [symbol] | |
| [symbol] | 12 | [symbol] | [symbol] | |
| [symbol] | 86 | [symbol] | κ | ® |
| [symbol] | 190 | [symbol] | [symbol] | − |
| [symbol] | 9 | [symbol] | Γ | ± |
| 3 | 342 | [symbol] | B | ² |
| ( | 114 | [symbol] | [symbol] | ³ |
| | 92 | [symbol] | [symbol] | \acute{ } |
| ) | 41 | [symbol] | [symbol] | μ |
| | 335 | √ | [symbol] | . |
| | 184 | No | [symbol] | ' |

Thus, four collectives were used that are not bounded to each other anyhow. To form the general collective of the first level, bit code tables were used, as well as pseudo graphical symbols of various operating systems, reserved symbols and user's custom number multitudes. The system allows for an unlimited amount of particular collectives.

The result of the message conversion after the use of the first level general collective looks as follows:

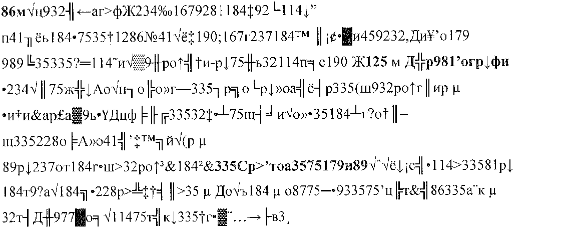

The example of encoding a symbol in a message can show that the same symbol is assigned different symbol values in different collectives of values, including the general one. The example of the Table 2 of collectives of values demonstrates that the symbol “c” of the message has the following values in the general collective of the first level

$$75 \qquad H \qquad ¥$$

These values represent a particular case for this collective of values, and for the random value generation at the next level they will change. The selection of the collectives of values will be randomized. The conversion of the first level general collective values into the system of bit information is carried out in such a way that assigning bit values to the first level general collective be randomized as well. In so doing, no consistency is maintained for the amount of bits per symbol for one particular symbol as well as for symbols and values in the entire encrypted message.

The result of encoding with the use of adding and enclosing the collectives looks as follows:

001110000011011011101100001111111111011000111001001100110011001000111 111001111111110000011100011001111101111010011000110001100100011001100 110100100010010011000100110110001101110011100100110010001110000011000 100110001001110000011010010000111001110010011001000111111001100010011 000100110100001111111001010011101111001101000011000100111111101110001 111110000110001001110000011010010010101001101110011010100110011001101 011000011000110001001100100011100000110110101110010011010000110001001 111111011100010000111001100010011100100110000001110110011000100110110 001101111110001100110010001100110011011100110001001110000011010010011 001001111110011111100111111100101010011111111101000001101000011010100 111001001100100011001100110010001011001100010011101000001111111001001 011101110001100010011011100111001001110010011100000111001001111110011 001100110101001100110011001100110101001111110011111100110001001100010 011010000111111111010000011111100111111001110010011111111110000111011 100011111100111111100001101110100000101101111100000011111100110111001 101010011111111111100001100110011001000110001001100010011010011101111 001111111111000100110001001110010011000011000110001100010011001000110 101001000001110110011000100001111111111000000111001001110000011000110 010010111011101110001111110000001111111111010011101000100101010011001 000110011001101000011111100111111001101110011010111100110001111110011 111111000100111011100011111111101101001111111110111000111111111011101 011101111100011100101110011001100110011001101010011111111110000001111 111110111000111111111100000011111110111011111011101110000000111111101 110000011111111110000001100110011001100110101001010001111100000111001 001100110011001011110000111011100011111111100011001111111110100011110 000101101011001010111101000100001101110100000100110111000001111000000 111111111000000011111100111001111111001001010100111111110001001111011 011110100001111110011111100111111001100110011001100110101001100110011 001010000111100101010011111100110111001101011111100100111111001111111 110100000111111111011101011101110010101001100110011010100110001001110 000011010000111111111000110011111111101110100001100011111110010110111 110010011001100110011001101010011001000110010001110001110111000111111 010000011011101111101110001101000011000100111111100100101000011110011 001001111111110100100111111001010001111000010110101001110000011100111 110000001111110011001000110011001101111110111011110010001100010011100 000110100111000111001010111111000001111100011001100110010111100001110 111000111111001111110010011000110001001110000011010000111111001001100 011001100110011001101011101000111110000001111101001001011110010111011 101110000000110011001101010011011100110101001100010011011100111001111 010000011100000111001001111110011111100111111101110000011111100111111 111100010011111110010101001100010011000100110100001111100011001100110 011001101010011100000110001111100000011111100110001001110000011010011 110010001110010011111111100000001111110011000100111000001101000011111 110010101001100100011001000111000111100000011111000111111100001111000 011000111111001111110011111000110011001101010010000010110101110001001 110111000111111111110100011000100111000001101000010000010110101001110 000011011100110111001101010011111110010101001110010011001100110011001 101010011011100110101100100101111011000111111111100100010011000111111 001110000011011000110011001100110011010111100000001111111110101010110 101001100110011001011110010001111111100010000111111001110010011011100 110111001111111110111000111111001111110011000100110001001101000011011 100110101111100100011111111101010001111110011001100110011001101011000 011011100011111011101001010100111111001111111000010100111111001111111 11000100011001100111111

The present invention can be implemented using various technologies including the technology of Cloud Computing. Involved in this case are the following services—Software as a service (SaaS), and Desktop as a Service (DaaS)—“Data as a service”. In the “Software as a service”, an encryption software system is implemented that allows a user access to the system interface by Internet or other networks. The “Desktop as a service” allows users to have a ready-to-work virtual workplace that can be customized according to user's particular needs. In so doing, the user utilizes processing power of an external server rather than of the user's personal computer. By using cloud computing, the problem of high-speed performance during multilevel, ‘deep’ encryption can be solved, and the problem of the interception of the encryption program interception is eliminated, as the user loads the information for encryption to the external server and it is only the already encrypted data that the user is provided with by the back channel.

Yet, to further improve security and protection of information, technology “Everything as a service” (EaaS) can be used, the technology being a model that combines elements of such technological solutions as the SaaS and “Infrastructure as a Service” (IaaS), providing miscellaneous computer infrastructure resources such as servers, data storage systems, network equipment, as well as software to control these resources. Also used can be such technologies as “Platform as a Service” (PaaS) provides a platform with specified features to develop, test, implement and support web-applications, etc.; “Workspace as a Service” (WaaS), which is similar to the DaaS, but unlike it, the user only has access to software, while all the computations take place in his/her computer; and other similar technologies using shared or personal resources.

Such a model of implementation allows efficient protection against harmful attacks for both the information and the systems where the method of the present invention is implemented, because users have no access to software. Besides, this concept lowers expenses on information system deployment and implementation.

Fields of use:

1. Applying protected information to materials, parts, pieces, items by different methods in a form of a message:

a. Defense industry—marking for the purpose of weapon and ammunition accounting and control.
b. Nuclear Power plants—marking for the purpose of nuclear material accounting and relocation control.
c. Governmental institutions—using the technology and the equipment during manufacturing for the protection against falsification of passports, identification cards and other documents.
d. Protection of securities, bank notes and documents, etc.
e. Aircraft industry—marking and identifying airplane parts, engines and other equipment.
f. Food industry—applying indelible marks and dates on products, including that during line production.
g. Car industry—marking car parts for the purpose of accounting and protection against counterfeit.
h. Machine-tool industry—making dials, scales, information labels marking.
i. Jewelry industry—applying marks during jewelry item production, also by assay supervision inspections for branding and identifying noble metal items.
j. Arts and crafts—for artwork protection.

2. Information protection during correspondence or communication of information on paper or similar carriers.

3. Protection of information on at miscellaneous digital carriers—encoded information is kept in digital form, level of protection remains unchanged.

4. Protection of information during its transmission over wired and wireless networks, including Internet.

1-7. (canceled)

8. A method of protecting information in the process of encoding the same in a system comprising a server and a user interface, the server being connected to, and remotely located with regard to, the user interface, the method comprising the steps of:
submitting to the user interface a multisymbol analog or digital information message to be protected,
digitizing the analog message,
providing Q collectives Aᵢ of encoding values, where i belongs to a multitude 1 . . . Q, the collectives being unbounded to each other, to thereby exclude obtaining values of one collective from values of another collective,
randomly selecting collectives for encoding the message, and
setting a random correspondence between symbols and encoding values of the selected collectives to randomly assign encoding values to the symbols of the message to produce an encoded message, each symbol being assigned at least one encoding value from at least one of the selected collectives,
said providing collectives and assigning encoding values to the message symbols being performed at the server to provide the user with the resulted encoded message only,
whereby the process of encoding the message is prevented from human access thereto.

9. The method according to claim 8 further comprising the steps of selecting at least one of the collectives for assigning encoding values to elements of the encoded message at least once, to thereby produce an at least once enclosed encoded message.

10. The method according to claim 8 wherein the length of the collective is independent from the length of the information message.

11. The method according to claim 8 wherein at least two of the selected collectives are added to each other prior to assigning their encoding values to the message symbols.

12. The method according to claim 8 wherein the server includes an encoder and a decoder implemented in a single environment physically protected against unauthorized access, writing and copying.

13. A method of protecting information in the process of encoding the same in a system comprising a server and a user interface, the server being connected to the user interface inaccessibly for the user, the method comprising the steps of:
submitting to the user interface a multisymbol analog or digital information message to be protected,
digitizing the analog message,
providing Q collectives Aᵢ of encoding values, where i belongs to a multitude 1 . . . Q, the collectives being unbounded to each other, to thereby exclude obtaining values of one collective from values of another collective,
randomly selecting collectives for encoding the message, and
setting a random correspondence between symbols and encoding values of the selected collectives to randomly assign encoding values to the symbols of the message to produce an encoded message, each symbol being assigned at least one encoding value from at least one of the selected collectives,
additionally selecting at least one of the collectives for assigning encoding values to elements of the encoded message at least once, to thereby produce an at least once enclosed encoded message,
said providing collectives and assigning encoding values being performed at the server to provide the user with the resulted encoded message only,
whereby the process of encoding the message is prevented from human access thereto.

14. The method according to claim 13 wherein the length of the collective is independent from the length of the information message.

15. The method according to claim 13 wherein at least two of the selected collectives are added to each other prior to assigning their encoding values to the message symbols.

16. The method according to claim 13 wherein the server includes an encoder and a decoder implemented in a single environment physically protected against unauthorized access, writing and copying.
